(19) United States
(12) Patent Application Publication
(10) Pub. No.: US 2016/0030926 A1
(43) Pub. Date: Feb. 4, 2016

(54) Compositions of Matter Comprising Nanocatalyst Structures, Systems Comprising Nanocatalyst Structures, and Related Methods

(71) Applicant: SEERSTONE LLC, Provo, UT (US)

(72) Inventor: Dallas B. Noyes, Provo, UT (US)

(73) Assignee: Seerstone LLC, Provo, UT (US)

(21) Appl. No.: 14/775,898

(22) PCT Filed: Mar. 13, 2014
(86) PCT No.: PCT/US2014/026706

§ 371 Date: Sep. 14, 2015

Related U.S. Application Data
(60) Provisional application No. 61/790,403, filed on Mar. 15, 2013.
(60) Provisional application No. 61/790,260, filed on Mar. 15, 2013.

(51) Int. Cl. B01J 23/745; C01C 1/04; C01B 13/02; C10G 2/00; B01J 37/16; B01J 37/02; B01J 37/34; B01J 23/89; C01B 3/40; C01B 21/02

(52) U.S. Cl. CPC B01J 23/745; C01B 3/40; C01C 1/0411; C01B 13/0203; C01B 21/02; B01J 37/16; B01J 37/0238; B01J 37/348; B01J 37/347; B01J 23/8906; C10G 2/00; C01B 2203/0227; C01B 2203/1047; C01B 2203/1241

(57) ABSTRACT

Methods of forming and producing nanocatalysts mounted on or within nanofiber or nanotube structures are disclosed. The mounting structures prevent the nanocatalysts from agglomerating and retain the nanocatalysts in a reactor. The nanocatalysts may be grown over a bulk catalyst material without treating the nanotubes after forming the nanotubes. The resulting nanocatalysts remain catalytically active immediately after formation of the mounting supports and are effective in a wide variety of reactions. Systems are disclosed for reacting reaction gases to form mounting structures with at least one embedded nanocatalyst in the growth tips. The mounting structures may catalyze a different, subsequent reaction than the nanofiber formation reaction, which may take place in the same or a different reactor. Methods of forming a mass of nanocatalysts and catalyzing a reaction with the mass of nanocatalysts are disclosed. Systems are disclosed for forming a mass of nanocatalysts and catalyzing another reaction with the mass of nanocatalysts.

### PRIORITY CLAIM

This application claims the benefit of the filing date of U.S. Provisional Patent Application Ser. No. 61/790,403, filed Mar. 15, 2013, for “Mounted Nanocatalysts and Methods of Forming Same,” and U.S. Provisional Patent Application Ser. No. 61/790,260, filed Mar. 15, 2013, for “Methods and Apparatuses for Catalyzing a Reaction,” the contents of each of which are incorporated herein by this reference.

### TECHNICAL FIELD

This disclosure relates to methods and systems for forming and mounting nanocatalysts on or within nanofibers or nanotubes. The resulting nanocatalyst structures remain catalytically active and are effective for a wide range of applications in a variety of reactions. The activity of the nanocatalysts may be enhanced by the presence of the nanofiber or nanotube mounting.

### BACKGROUND

Nanoparticles are effective catalysts because of their extremely high specific surface area in which catalyst materials are divided into extremely small nanoparticles. Many compositions of nanoparticles are suitable for use as nanocatalysts for a wide variety of reactions. The development of nanoparticle catalysts is a promising route for improvements in a wide variety of reactions. The widespread use of nanocatalysts has been hindered by many factors, including high cost of manufacture; clumping, agglomeration, and merging of nanocatalysts into large particles under reactor conditions; increased pressure drop caused by nanocatalysts; and removal of nanocatalyst from reactors by elutriation of the nanocatalysts entrained in process streams.

Typical methods of mounting nanocatalysts on a nanofiber include forming nanofibers and then washing or rinsing the nanofibers in an acid solution to remove the catalyst embedded in the growth tip of the nanofibers and then subsequently depositing particles within the nanofiber. The nanofibers are often grown over a metal catalyst deposited on a support material such as silicon dioxide. The metal catalyst is often formed by methods such as precipitation of the metal onto the support material as disclosed in U.S. Pat. No. 6,913,740 issued Jul. 5, 2005, and titled “Graphite Nanocatalysts.” Some methods include the additional step of adding particular precipitating agents to the solution. After the nanofiber is washed, rinsed, or otherwise treated in an acid solution, the nanofiber is often coated with a catalyst material by processes such as impregnation, incipient wetness, or precipitation of a catalyst material onto the nanocatalyst structure to bond catalyst particles to the nanocatalyst structure.

It would be desirable to quickly form uniformly nanocatalyst structure particles with uniform size and shape distribution at a reduced cost of manufacture. It would be further desirable to form nanocatalyst particles having a reduced tendency to entrain in process fluids and a reduced tendency to agglomerate or clump under reactor conditions.

U.S. Pat. No. 7,794,690 (Abatzoglou et al.) teaches a dry reforming process for sequestration of carbon from an organic material. Abatzoglou discloses a process utilizing a 2D carbon sequestration catalyst with, optionally, a 3D dry reforming catalyst. For example, Abatzoglou discloses a two-stage process for dry reformation of an organic material (e.g., methane, ethanol) and CO₂ over a 3D catalyst to form syngas, in a first stage, followed by carbon sequestration of syngas over a 2D carbon steel catalyst to form CNTs and carbon nanofilaments. The 2D catalyst may be an active metal (e.g., Ni, Rh, Ru, Cu—Ni, Sn—Ni) on a nonporous metallic or ceramic support, or an iron-based catalyst (e.g., steel), on a monolith support. The 3D catalyst may be of similar composition, or may be a composite catalyst (e.g., Ni/ZrO₂—Al₂O₃) over a similar support. Abatzoglou teaches preactivation of a 2D catalyst by passing an inert gas stream over a surface of the catalyst at a temperature beyond its eutectic point, to transform the iron into its alpha phase. Abatzoglou teaches minimizing water in the two-stage process or introducing water in low concentrations (0 to 10 wt %) in a reactant gas mixture during the dry reformation first stage.

### DISCLOSURE

A method of forming a composition of matter includes reacting gaseous reactants in a reaction zone in the presence of a bulk catalyst material to grow nanocatalyst structures comprising a mass of nanofibers having at least one particle of the bulk catalyst material attached to a growth tip of a substantial quantity of the nanofibers of the mass of nanofibers. After the nanofibers are formed, additional catalytic material may be deposited on at least one of an exterior surface and an interior surface of the nanofibers.

A nanocatalyst structure includes at least one particle of catalyst material embedded on at least one end of a nanofiber and at least another particle of catalyst material attached to an exterior surface of the nanofiber. The nanofiber may be a different material than the at least one particle of catalyst embedded on the at least one end of the nanofiber. The at least another particle of catalyst material attached to an exterior surface of the nanofiber may be a different material than the at least one particle of catalyst material embedded on at least one end of the nanofiber.

A system for catalyzing a reaction using nanocatalysts includes at least one first reaction zone for forming a mass of nanocatalyst structures and a tail gas from a first combination of reactants, wherein at least one surface of the first reaction zone comprises a bulk catalyst material for catalyzing the formation of the mass of nanocatalyst structures and at least another reaction zone for catalyzing another reaction with a second combination of reactants.

A composition of matter includes a nanocatalyst structure comprising a nanofiber with at least one particle of catalyst material embedded on at least one end of the nanofiber and at least another particle of catalyst material attached to an exterior surface of the nanocatalyst structure.

A method of forming nanocatalysts on nanofibers includes preconditioning a bulk catalyst material by performing at least one of reducing a surface of the bulk catalyst material, oxidizing a surface of the bulk catalyst material, and annealing a surface of the bulk catalyst material, and growing a multitude of nanofibers over the bulk catalyst material, wherein a growth tip of a substantial number of nanofibers contains at least one nanoparticle of the bulk catalyst material or of a constituent of the bulk catalyst material.

A method of forming a mass of nanocatalysts includes annealing, reducing, or carburizing at least a portion of a surface of a bulk catalyst material to form a preconditioned surface of the bulk catalyst material, growing a mass of nanofibers over the at least a portion of the preconditioned surface of the bulk catalyst material, and depositing at least another catalyst material on the mass of nanofibers to form the mass of nanocatalyst structures.

A mixture of nanocatalyst structures includes a first group of nanofibers, each nanofiber of the first group comprising at least one particle of at least a first catalyst material embedded in at least one end thereof, and a second group of nanofibers, each nanofiber of the second group comprising at least one particle of at least a second catalyst material embedded in at least one end thereof.

A method of catalyzing a reaction includes forming a multitude of nanocatalyst structures from a bulk catalyst material comprising at least one element of Groups 5 through 11 of the periodic table, wherein a substantial quantity of the multitude of nanocatalyst structures contain at least one nanocatalyst particle and catalyzing at least one reaction with the multitude of nanocatalyst structures formed from the bulk catalyst material.

A system for catalyzing a reaction using nanocatalyst structures includes at least one reactor zone for forming a multitude of nanofibers from a first combination of reactants, wherein the multitude of nanofibers comprises at least one nanocatalyst particle attached at or near a proximal end of substantially all nanofibers of the multitude of nanofibers, a means for depositing additional catalytic material onto an exterior surface of substantially all nanofibers of the multitude of nanofibers to form the nanocatalyst structures, and a means for catalyzing another reaction with a second combination of reactants using the nanocatalyst structures.

In certain embodiments hereof, the partial pressure of water in the reaction is regulated by various means, including recycling and condensation of water, to influence, for example, the structure or other aspects of the composition of carbon products produced. The partial pressure of water appears to assist in obtaining certain desirable carbon allotropes.

In certain embodiments, a broad range of inexpensive and readily-available catalysts, including steel-based catalysts, are described, without the need for activation of the catalyst before it is used in a reaction. Iron alloys, including steel, may contain various allotropes of iron, including alpha-iron (austenite), gamma iron, and delta-iron. In some embodiments, reactions disclosed herein advantageously utilize an iron-based catalyst, wherein the iron is not in an alpha phase. In certain embodiments, a stainless steel containing iron primarily in the austenitic phase is used as a catalyst. In yet other embodiments the bulk catalyst is carburized so that the crystalline structure is partially or substantially saturated with carbon. If iron-based catalysts, such as steel, are used, carburization results in a substantial increase in the cementite in the bulk catalyst.

In some embodiments, the catalyst is deposited as a layer on an underlying inert substrate (e.g. ceramic, quartz, or non-catalytic metallic) that provides solid support for the catalyst. In other embodiments, catalysts, including an iron-based catalyst (e.g., steel, steel wool), may be used without a need for an additional solid support. In certain embodiments, reactions disclosed herein proceed without the need for a ceramic or metallic support for the catalyst. Omitting a solid support may simplify the setup of the reactor and reduce costs.

In yet other embodiments the catalyst may be introduced to or formed with the reactor as an aerosol of nanoparticles from which the nanostructures, such as carbon nanotubes, are grown. In such cases there is no bulk catalyst or catalyst support.

A reactor may be coupled with heating and cooling mechanisms to control the temperature of the reactor. For example, a reactor may be configured such that products and excess reactant are recycled through a cooling mechanism to condense water vapor. The products and/or excess reactant may then be reheated and recycled through the reactor. By removing some of the water vapor in the recycled gases, the morphology of solid carbon formed may be controlled. Changing the partial pressure of water vapor changes the carbon activity of a mixture. The reactor may also be coupled to a carbon collector in which water and unreacted reactants are separated from the carbon products. The separated carbon products are collected and removed from the system.

### BRIEF DESCRIPTION OF THE DRAWINGS

FIG. 1 is a scanning electron microscope (SEM) image of iron nanocatalysts mounted on carbon nanotubes;

FIG. 2 is a transmission electron microscopy (TEM) image of iron nanocatalysts mounted on carbon nanotubes;

FIG. 3a is a simplified schematic diagram of a nanofiber with a nanocatalyst structure in a growth tip and nanocatalyst structures on the surface of the nanofiber;

FIG. 3b is a simplified schematic diagram of a bulk catalyst material with nanocatalyst structures formed thereon;

FIG. 4 is a simplified schematic diagram of a tube or pipe with nanocatalyst structures formed on the internal diameter of the tube or pipe;

FIG. 5 is a simplified schematic diagram of a spherical catalyst material with nanocatalyst structures formed thereon;

FIG. 6 is a simplified schematic diagram of an apparatus for forming nanocatalyst structures.

FIG. 7 is a simplified schematic diagram of an apparatus for forming nanocatalyst structures in batch mode;

FIG. 8a is a simplified schematic diagram of an apparatus for forming nanocatalyst structures in continuous mode; and

FIG. 8b is simplified schematic diagram of an apparatus for forming nanocatalyst structures in continuous mode, including recycle streams.

### MODE(S) FOR CARRYING OUT THE INVENTION

This disclosure includes methods and systems for forming nanocatalyst structures. Nanocatalyst structures include nanofibers, nanotubes, or nanofilaments wherein at least one catalytic particle or grain is attached on at least one end of each nanofiber, nanotube, or nanofilament. Nanofibers, nanotubes, and nanofilaments may each encompass various sizes, shapes, forms, and morphologies.

As used herein, the term “nanofibers” means and includes nanofibers, nanotubes, and nanofilaments and may include other morphologies, such as platelets. As used herein, the term “plurality of nanofibers” means and includes a mass of nanofibers, a multitude of nanofibers, a group of nanofibers, or a group of nanofibers that may be grown from a catalyst material.

As used herein, the term “nanocatalyst structures” means and includes a composition of matter including at least one nanofiber with at least one catalyst particle mounted on or supported by the at least one nanofiber. Additional catalyst may be deposited on the surfaces of the nanofiber, in which case they become part of the nanocatalyst structures.

As used herein, “catalyst particle” and “nanocatalyst particle” are used synonymously in this disclosure to mean a particle of catalyst with a characteristic dimension of less than 1 nanometer (such as less than about 1 micrometer). Nanocatalyst particles consist of a dissimilar material from the nanofibers to which they are attached. Nanocatalyst particles are at least attached to one end of the nanofiber to form a nanocatalyst structure, and additional catalyst particles may be deposited on the surfaces of the nanocatalyst structure. The catalyst particles in the nanocatalyst structure may be of a different material than catalyst particles deposited on or attached to the surfaces of the nanocatalyst structure.

Nanofibers generally grow from a nanocatalyst nucleating site on the surface of a bulk catalyst material, or from catalyst particles in an aerosol. During the growth of the nanofibers, nanocatalyst particles from the surface of the bulk catalyst material are raised from the surface of the bulk catalyst and become the growth tip of the nanofibers. The nanocatalyst particles become embedded in or attached to the growth tips and are supported by the resulting nanofibers. Thus, nanocatalyst structures are made from a solid, bulk catalyst material. The methods disclosed herein may thus be used to subdivide the bulk catalyst material into nanocatalyst structure particles. The resulting nanocatalyst structures remain catalytically active and may be suitable for many industrial reactions. The nanofibers upon which the nanocatalysts are mounted may help to keep the nanocatalyst structures from agglomerating or merging and provide a larger scale structure that can retain the nanocatalyst structure in the reactors.

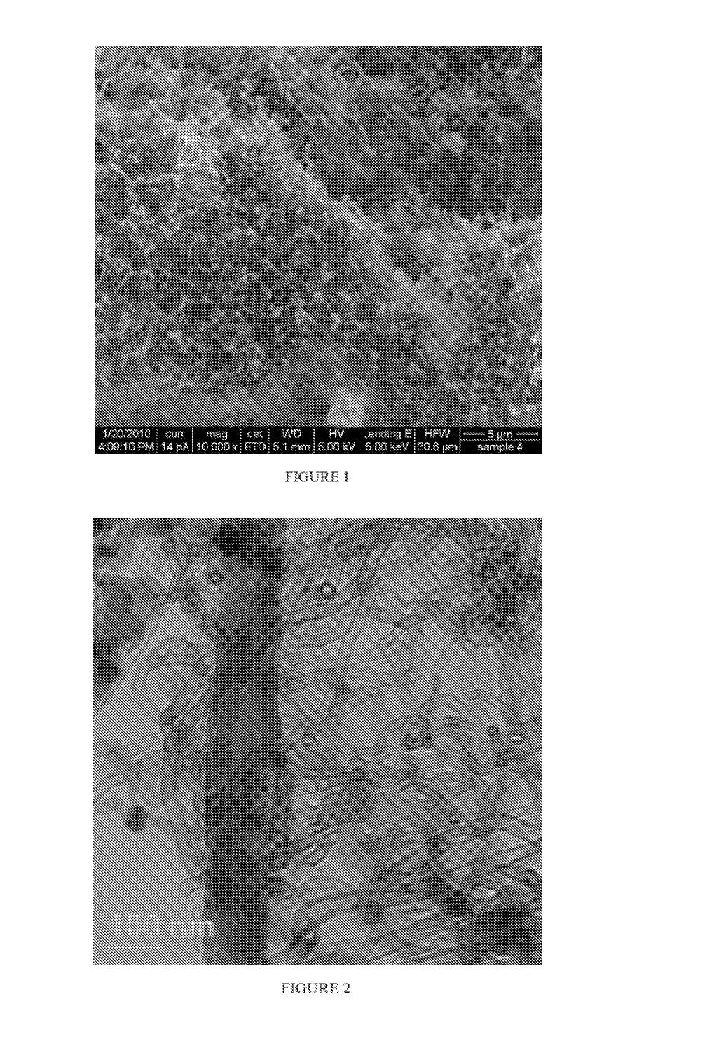

In some embodiments, the combination of the nanocatalyst particle and the nanofibers may be more catalytically active than the nanocatalyst particle alone. Careful selection of the catalyst and the dissimilar nanofiber chemistries can optimize the nanocatalyst structures for particular reactions. FIGS. 1 and 2 are SEM images of nanocatalyst structures including iron nanocatalyst particles mounted on the ends of carbon nanotubes (CNTs). As seen in FIGS. 1 and 2, nanocatalyst particles become embedded in the tips of the growing nanocatalyst structure during nanotube formation. The iron nanocatalyst particles appear brighter in FIG. 1 than the nanofibers on which they are mounted. A nanocatalyst particle is separated from and raised off of the bulk catalyst surface as each nanofiber is formed. In one embodiment, each nanocatalyst particle contains at least one atom from the bulk catalyst surface embedded at the proximal end of the nanotube. The distal end of the nanotube remains initially attached to the bulk catalyst surface and may subsequently detach as additional generations of nanocatalyst structures are formed. Without being bound by any particular theory, it appears that the bulk catalyst surface is slowly consumed in each reaction cycle. Thus, as used herein, when referring to a bulk catalyst material, the term “catalyst” means and includes a material formulated to promote one or more reactions resulting in a nanofiber with at least one nanocatalyst particle attached to the nanofiber. A portion of the catalyst may be removed from a surrounding portion of the bulk material during the reaction. The bulk catalyst may need to be continually replenished during the reaction. The portion of the bulk material may not therefore be considered a catalyst in the classical sense, but is nonetheless referred to herein and in the art as a “catalyst” if the reaction is not believed to alter chemical bonds of the bulk material.

When using a solid catalyst, such as a wafer of bulk metal catalyst, many nanofibers grow in a series of generations over the surface of the bulk catalyst. Though the mechanism is not fully understood, it appears that reaction gases interact with nanocatalyst particles forming on the exposed surface of the bulk catalyst material and nanofibers begin to grow on these nanocatalyst particles. As the growth continues, it appears that neighboring nanofibers become entangled and lift the newly formed nanocatalyst structure particles off of the bulk catalyst surface, exposing a new layer of catalyst material, with which reaction gases are then able to interact. The observation that the layers detach from the underlying catalyst substrate suggests that the resulting nanofibers may easily be removed from the surface of the bulk catalyst and the process may operate continuously until the bulk catalyst is consumed. As the reaction continues and each layer of nanofiber material is formed, the newly exposed bulk catalyst surface acts as a nucleating site for the next layer of nanofiber formation. As used herein, the term “bulk catalyst” surface may include a solid material, a ceramic or other material or substrate on which a suitable catalyst for nanofiber formation may be deposited or formed. In some embodiments, the bulk catalyst may include a catalytic material formed (e.g., formed) on an underlying substrate such as quartz, ceramic, or a non-catalytic material.

Nanocatalyst particles embedded in nanofiber growth tips are particles removed from the bulk catalyst material from which the nanofibers are grown. In some embodiments, the properties of the nanocatalyst particles reflect the properties of the bulk catalyst from which the nanotube is formed. Thus, in some embodiments, by altering the physical and chemical properties of the bulk catalyst material, the properties of the resulting may be controlled. Thus, nanocatalyst structures having nanocatalyst particles having the same composition, or similar physical, chemical, or catalytic properties as the bulk catalyst are formed.

After formation, the nanocatalyst structures may be removed from the bulk catalyst surface and harvested for subsequent use in another process. The nanocatalyst structures over the bulk catalyst may catalyze another entirely different reaction than the nanofiber formation reaction without consuming either the nanofiber or nanocatalyst of the nanocatalyst structure. For example, nanocatalyst structures including nanofibers of carbon nanotubes and nanocatalyst particles of iron are effective catalysts for the Haber-Bosch and Fischer-Tropsch reactions.

The methods disclosed may be suitable for mounting nanocatalyst particles on a variety of nanofiber chemistries. Non-limiting examples of suitable nanofibers include carbon nanofibers, boron nitride nanotubes, boron carbide nanotubes, alumina nanofibers, cadmium sulfide nanofibers, carbon nitride nanofibers, titania nanofibers, silicon nanofibers, and silicon dioxide nanofibers.

By way of non-limiting example, silicon nanofibers may be formed from a gold catalyst or from a nickel- or zinc-based catalyst, thereby embedding the catalyst particle on the growth tip of the grown silicon nanofiber. As another example, a plurality of boron nitride nanofibers may be formed from an iron catalyst supported on an SiO₂ and/or Al₂O₃ support material, resulting in a boron nitride nanofiber with embedded iron nanocatalysts at the nanofiber growth tip. In yet another example, carbon nanotubes are formed by reacting a carbon-containing gas (CO, CO₂, etc.) with a reducing agent (H₂, CH₄, etc.) in a reaction zone including a catalytic metal such as iron, nickel, chromium, platinum, palladium, etc., at a temperature between about 500° C. and 800° C. In one embodiment, carbon dioxide is reacted with a reducing agent to form the nanofibers. In one embodiment, the reducing agent is H₂. In another embodiment, the reducing agent is a hydrocarbon (e.g., CH₄, C₂H₅, etc.) or an alcohol (e.g., methanol, etc.). The resulting nanocatalysts embedded in the growth tips of such nanotubes remain catalytically active and may catalyze a variety of chemical reactions. Boron carbide nanofibers may be formed with porous alumina templates wherein a precursor (such as 6,6′-(CH₂)₆—(B₁₀H₁₃)₂) is placed in the alumina template as described in Mark J. Pender et al., Molecular and Polymeric Precursors to Boron Carbide Nanofibers, Nanocylinders, and Nanoporous Ceramics, (Pure Appl. Chem., Vol. 75, No. 9, pp. 1287-1294, 2003). The template is heated to approximately 140° C. and then subsequently dissolved with, for example, a hydrofluoric acid solution, leaving boron carbide nanofibers. Alternatively, boron carbide nanofibers may be formed by reacting carbon nanotubes with boron powder at approximately 1150° C. Alumina nanofibers may be formed by various methods such as the internal crystallization method and extrusion, electrospraying, electrospinning, CVD, and sol-gel methods, as known in the art, as described in Mohamad Ridzuan Noordin & Kong Yong Liew, Synthesis of Alumina Nanofibers and Composites in Nanofibers, (Ashok Kumar ed., 2010), 405, 405-418. As another non-limiting example, carbon nitride nanofibers may be formed by pyrolysis of melamine over a catalyst material such as nickel or iron. Cadmium sulfide nanofibers may be formed by electro-deposition or by electrospinning. Titania nanofibers may be formed by a direct sol-gel process or electrospinning. Any of the above-mentioned nanofibers may be formed using any of the methods known in the art or subsequently developed.

Due to the wide range of materials that can be used for both the bulk catalyst and for the nanofibers of the nanocatalyst structures, examples below use primarily iron based catalyst with carbon nanotubes. However, the disclosure is not so limited, and the usage of carbon nanotubes is not a limitation on the invention, but rather a specific illustration of the principals of the disclosure.

Suitable catalysts for the production of the nanocatalyst structures described herein include elements of Groups 1 through 15 of the periodic table (e.g., Groups 2 through 11), lanthanides, actinides, oxides of such elements, alloys of such elements, and combinations thereof. Non-limiting examples of suitable catalyst materials include vanadium, niobium, tantalum, chromium, molybdenum, tungsten, manganese, rhenium, iron, ruthenium, osmium, cobalt, rhodium, iridium, nickel, palladium, platinum, and alloys thereof. Note that the periodic table may have various group numbering systems. As used herein, group 2 is the group including Be, group 3 is the group including Sc, group 4 is the group including Ti, group 5 is the group including V, group 6 is the group including Cr, group 7 is the group including Mn, group 8 is the group including Fe, group 9 is the group including Co, group 10 is the group including Ni, group 11 is the group including Cu, group 12 is the group including Zn, group 13 is the group including B, group 14 is the group including C, and group 15 is the group including N. In some embodiments, commercially available metals are used without special preparation. Useful catalysts may include some commercially available metals because such metals may be used without further catalyst preparation.

304 stainless steel appears to catalyze the formation of carbon nanotubes under a wide range of temperatures, pressures, and gas compositions. However, the rate of formation of CNTs on 304 stainless steel appears to be relatively low, such that 304 stainless steel may be used effectively as a construction material for process equipment, with minimal deposition on surfaces thereof in normal operations. 316L stainless steel, in contrast, appears to catalyze the formation of solid carbon at significantly higher rates than 304 stainless steel, but may also form various morphologies of carbon. Thus, 316L stainless steel may be used as a catalyst to achieve high reaction rates, but particular reaction conditions may be maintained to control product morphology. Catalysts may be selected to include Cr, such as in amounts of about 22% or less by weight. For example, 316L stainless steel contains from about 16% to about 18.5% Cr by weight. Catalysts may also be selected to include Ni, such as in amounts of about 8% or more by weight. For example, 316L stainless steel contains from about 10% to about 14% Ni by weight. Catalysts of these types of steel have iron in an austenitic phase, in contrast to alpha-phase iron used as a catalyst in conventional processes. Given the good results observed with 316L stainless steel, the Ni and/or Cr may have a synergistic effect with Fe.

Oxidation and subsequent reduction of the bulk catalyst surface alter the grain structure and grain boundaries. Without being bound by any particular theory, oxidation appears to alter the surface of the metal catalyst in the oxidized areas. Subsequent reduction may result in further alteration of the bulk catalyst surface. Thus, the grain size and grain boundary of the bulk catalyst may be controlled by oxidizing and reducing the catalyst surface and by controlling the exposure time of the catalyst surface to the reducing gas and the oxidizing gas. The oxidation and/or reduction temperatures may be in the range from about 500° C. to about 1,200° C., from about 600° C. to about 1,000° C., or from about 700° C. to about 900° C. The resulting gain size may range from about 0.1 μm to about 500 μm, from about 0.2 μm to about 100 μm, from about 0.5 μm to about 10 μm, or from about 1.0 μm to about 2.0 μm. In some embodiments, the bulk catalyst may be an oxidized metal (e.g., rusted steel) that is reduced before or during a reaction forming solid carbon. Without being bound to any particular theory, it is believed that removal of oxides leaves voids or irregularities in the surface of the catalyst material, and increases the overall surface area of the bulk catalyst material.

The bulk catalyst may be in the form of plates, foil, sheets, cylinders, pellets, spheres of various diameters, or combinations thereof. Nanotube structures may, in many cases, be formed directly on the bulk catalyst without further treatment of the bulk catalyst prior to nanofiber formation. In other cases, pretreating may be desirable, for example, by acid washing, reduction, heat treating (e.g., recrystallizing, annealing, etc.), etching, etc.

Thus, a unique method of forming nanocatalyst structures is provided wherein the nanocatalysts are prepared from a bulk catalyst, without the need for a catalyst support comprised of a material that is substantially different than the bulk catalyst material. Alternatively, a bulk material such as a ceramic may be coated with a thin catalyst material of precious metal such as palladium, platinum, or ruthenium from which nanofibers are grown. In another embodiment, the nanofiber-forming catalyst is a commercially available metal in powdered form. By way of non-limiting example, powdered stainless steel may be used as the catalyst material on which nanocatalyst structures are formed. Powdered or granular metals may be used for the formation of nanofibers described herein. Altering the mean diameter of the powdered metals may alter the size of the nanocatalysts, wherein a smaller powder diameter results in smaller nanocatalyst particles embedded in the growth tip of resulting nanofibers.

The bulk catalyst may be in the form of catalyst powder or in the form of domains or grains and grain boundaries within the solid metal catalyst. Catalyst metals of a particular chemical composition are selected wherein the grain size of the metal has a characteristic dimension for the diameter of the desired nanofiber. The grain size and grain boundary influence the distance between adjacent nanofibers and may influence the size and the specific surface area of the resulting nanocatalyst structures. In some embodiments, the catalyst may be formed over a substrate or support, such as an inert oxide that does not participate in the reactions. However, the substrate is not necessary; in other embodiments, the catalyst material is an unsupported material, such as a bulk metal or particles of metal not connected to another material (e.g., loose particles, shavings, or shot, such as may be used in a fluidized-bed reactor).

As a non-limiting example, carbon nanotubes of various shapes, morphologies, and physical and chemical characteristics are formed by altering the bulk catalyst or the catalyst surface on which the nanotubes are formed. Typically, the diameter of the nanotube structure is a function of the diameter of the nanocatalyst particle that forms the growth tip of the nanotube. Thus, the nanotube size is controlled by altering the chemical composition and surface structure of the bulk catalyst on which the catalyzing nanocatalyst particle is located. The size and morphology of the nanotube structures are typically controlled by controlling the bulk catalyst surface (e.g., grain size, gain boundary), reaction time, reaction gas flow rate, reactor temperature and pressure, and the chemical composition of the bulk catalyst.

The reaction conditions, including the temperature and pressure in a reaction zone, the residence time of the reaction gases, and the grain size, grain boundary, and chemical composition of the bulk catalyst may be controlled to obtain solid carbon products of the desired characteristics. The feed gas mixture and reaction product are typically recycled through the reaction zone and passed through a condenser with each cycle to remove excess water and to control the partial pressure of the water vapor in the reaction gas mixture. The partial pressure of water is one factor that appears to affect the type and character (e.g., morphology) of solid carbon formed, as well as the kinetics of carbon formation.

Carbon activity (A_{c}) can be used as an indicator of whether solid carbon will form under particular reaction conditions (e.g., temperature, pressure, reactants, reactant and product concentrations). Without being bound to any particular theory, it is believed that carbon activity is the key metric for determining which allotrope of solid carbon is formed. Higher carbon activity tends to result in the formation of CNTs, lower carbon activity tends to result in the formation of graphitic forms of carbon.

Carbon activity for a reaction forming solid carbon from gaseous reactants can be defined as the reaction equilibrium constant times the partial pressure of gaseous products, divided by the partial pressure of reactants. For example, in the reaction, CO_{(g)}+H_{2(g)} [symbol] C₍ₛ₎+H₂O_{(g)}, with a reaction equilibrium constant of K, the carbon activity A_{c} is defined as K·(P_{CO}·P_{H2}/P_{H2O}). Thus, A_{c} is directly proportional to the partial pressures of CO and H₂, and inversely proportional to the partial pressure of H₂O. Higher P_{H2O} tends to inhibit CNT formation. The carbon activity of this reaction may also be expressed in terms of mole fractions and total pressure: A_{c}=K·P_{T}(Y_{CO}·Y_{H2}/Y_{H2O}), where P_{T} is the total pressure and Y is the mole fraction of a species. Carbon activity generally varies with temperature because reaction equilibrium constants vary generally with temperature. Carbon activity also varies with total pressure for reactions in which a different number of moles of gas are produced than are consumed. Mixtures of solid carbon allotropes and morphologies thereof can be achieved by varying the catalyst and the carbon activity of the reaction gases in the reactor.

Metals with smaller mean grain sizes tend to produce smaller diameter nanofibers. The grain size is both a function of the chemistry of the metal catalyst and of the heat-treating methods and processing history (e.g., work hardening) under which the gains are formed. Not only is the mean diameter of resulting nanofibers controlled by altering the catalyst surface grain size, changing the grain size and grain boundary of the catalyst surface also changes the nanofiber density grown over the bulk catalyst surface. There is some evidence that larger grain boundaries of the catalyst metal surface correspond to nanofibers spaced further apart. Thus, by altering the grain boundary of the bulk catalyst surface, the morphology and spacing of resulting nanofibers may be controlled. The grain size and grain boundary of the bulk catalyst may be preconditioned by recrystallizing or annealing the bulk catalyst, reducing the surface of the bulk catalyst, oxidizing the surface of the bulk catalyst, carburizing the surface of the bulk catalyst, sputtering (ion bombardment) of a material onto the bulk catalyst surface, chemical etching, electro-chemical deposition (also known as electro-deposition or electro-plating), chemical vapor deposition (CVD), atomic layer deposition (ALD), or organometallic deposition on the bulk catalyst surface. By way of non-limiting example, when depositing metal particles by ALD, CVD, sputtering, or electro-chemical deposition on, for example, a silicon substrate, the mean grain size may be as low as approximately 1 nm.

In certain embodiments, the grain size and grain boundary of the bulk catalyst surface is changed to control the size and morphology of the nanofiber. Changing the grain size or the grain boundary has an effect on the chemical and physical composition of the bulk catalyst surface. Such changes may be effected by heating the bulk catalyst to a temperature above the recrystallization temperature, holding the temperature for a suitable period of time, and subsequently cooling the metal. Higher temperatures above the critical temperature and longer heating times correspond to larger crystal formations. A faster cooling rate from the recrystallization temperature results in a larger maximum undercooling and a greater number of nucleation sites, thus producing a finer-grained metal. For example, the bulk catalyst may be annealed or recrystallized at a temperature range from about 600° C. to about 1,100° C., from about 650° C. to about 1,000° C., from about 700° C. to about 900° C., or from about 750° C. to about 850° C. The mean grain size may be controlled between about 0.1 μm and about 50 μm, between about 0.2 μm and about 20 μm, between about 0.5 μm and about 5 μm, or between about 1.0 μm and about 2.0 μm. Various heat treating, annealing, and quenching methods are known in the art of metal preparation, grain growth techniques, and grain refinement. Any of these methods may be used to alter the grain size and grain boundaries of the bulk catalyst surface, to control the size and morphology of the resulting nanotube and nanocatalyst structure.

In some embodiments, the grain size and grain boundary of the bulk catalyst surface are controlled by reducing the bulk catalyst surface prior to nanofiber formation. For example, a reducing gas mixture (e.g., hydrogen) may be introduced into the reactor, and the reducing gas temperature, pressure, and concentration are controlled to reduce the surface of the bulk catalyst. The grain size and grain boundary of the bulk catalyst are controlled by heating the bulk catalyst surface and reducing any oxides on the surface. Treating the bulk catalyst surface in the reducing environment for longer periods of time generally results in larger grain sizes. Thus, shorter reducing treatments generally result in smaller grain sizes. Similarly, lower reducing temperatures result in smaller grain sizes in the bulk catalyst surface. In some embodiments, oxidation of the bulk catalyst surface and subsequent reduction alters the grain structure and grain boundaries of the bulk catalyst surface. Without being bound by any particular theory, oxidation may alter the surface of the metal catalyst in the oxidized areas. Then, subsequent reduction may result in further alteration of the bulk catalyst surface. The oxidation and/or reduction temperature is typically in the range of from about 500° C. to about 1,200° C., from about 600° C. to about 1,000° C., or from about 700° C. to about 900° C.

In some embodiments, the bulk catalyst surface is controlled by chemical etching of the metal surface. The etching may result in a bulk catalyst surface of a particular mean grain size and with a particular grain boundary. The etching process is completed by swabbing, immersion, spraying, or other methods known in the art of metal etching. The type of etchant, the strength of the etchant, and the etching time may be controlled to control the surface of the bulk catalyst. For example, to etch a bulk catalyst such as nickel-containing alloys or superalloys, a suitable etchant may include a solution of 100 ml ethanol with 100 ml HCl per 5 grams of CuCl₂. Alternatively, various strengths of nitric acid may be used to etch the bulk catalyst. If a bulk catalyst contains cobalt, the bulk catalyst may be etched in a solution of hydrochloric acid and ferric chloride. Thus, if the bulk catalyst includes a cobalt alloy, such an etchant may selectively etch the cobalt, while the remaining metals on the surface of the bulk catalyst remain. If the bulk catalyst is steel, the etchant may be a solution of HCl, glycerol, and HNO₃ in approximately a 2:3:1 ratio, respectively. Other etchants for iron-containing metals include an alcohol (e.g., methanol, ethanol, etc.) and nitric acid in an approximately 9:1 ratio. Alternatively, the etchant may include ethanol and picric acid, or mixtures of hydrochloric acid, ethanol, water, and nitric acid. Various other etchants and etching solutions known in the field of metal etching may be used as described.

In some embodiments, the grain boundary and the mean grain size of the bulk catalyst surface are controlled by sputtering. For example, sputtering may be used to deposit thin materials onto a surface. A target material including the metal to be deposited is contacted with an energy source and atoms from the target material are deposited onto a substrate. In one embodiment, nanofibers are formed from a bulk catalyst such as an iron catalyst. Then, additional nanocatalyst is formed on the nanofibers by sputtering. This may be an advantageous way to increase the surface area of an expensive catalyst material without forming the nanofiber from an expensive bulk catalyst. By way of non-limiting example, a carbon nanotube is formed from a bulk iron catalyst, and at least one of platinum, palladium, and ruthenium is deposited on the carbon nanotube by sputtering. Thus, sputtering is one method of beginning from a relatively inexpensive bulk material (e.g., iron), growing nanotubes, and then forming expensive nanocatalysts (e.g., platinum, palladium, ruthenium etc.) supported on the nanotubes. Alternatively, one or more nanolayers of material such as platinum, palladium, or rhodium may be formed over a bulk substrate material (which may be inert) by sputtering. Then, nanotubes are grown over the sputtered material overlying the bulk substrate. The resulting nanocatalyst structures have nanocatalyst particles of the sputtered material embedded at or near the growth tip of the nanotubes.

Alternatively, the bulk catalyst surface may be altered by means such as electro-chemical deposition. Suitable metal materials, such as one or more of vanadium, niobium, tantalum, chromium, molybdenum, tungsten, manganese, rhenium, iron, ruthenium, osmium, cobalt, rhodium, iridium, nickel, palladium, platinum, and alloys thereof, may be deposited on a metal catalyst surface by electro-chemical deposition. Electro-chemical deposition may be performed either prior to, or after, forming the nanocatalyst structures. For example, subjecting nanotubes to electro-chemical deposition results in a nanotube with several nanocatalyst particles mounted on the nanotube surface. However, generally, electro-chemical deposition is performed prior to nanotube formation because electro-chemical deposition after nanotube formation often plugs the pores of the network of the nanocatalyst structures, resulting in an increased pressure drop through the nanocatalyst structures. Increasing the time of electro-chemical deposition results in an increased amount of catalyst material deposited on the catalyst surface. Altering the current of the electro-chemical deposition process may also affect the resulting surface of the deposited metal. For example, decreasing the current may result in a lower mass of deposited material. As a non-limiting example, a portion of a bulk catalyst surface is partially coated with a desired catalyst by an electro-chemical deposition process, resulting in a particular grain structure and grain boundary. The partial coating of desired catalyst may include the same material as the bulk catalyst or may include other catalyst materials. Nanotubes or nanofibers grown over the resulting bulk catalyst surface exhibit a unique composition of nanocatalyst particles, such as nanocatalyst particles comprising two or more metals.

By way of non-limiting example, nickel-alumina nanocatalyst structures may be formed by depositing a thin nickel layer over an aluminum bulk metal surface, or alternatively, by depositing an aluminum material over a nickel substrate. In either case, formed nanofibers include nanocatalyst particles of the bulk catalyst material and of the thin layer formed over the bulk catalyst material. Other non-limiting examples of preparing catalyst include depositing a chromium material over a nickel or cobalt bulk catalyst, and depositing platinum over a ruthenium-containing metal. In another embodiment, a nanofiber is grown from a platinum bulk catalyst or a substrate plated with platinum. The nanofibers are subsequently plated with nickel by subjecting them to an electro-chemical deposition solution, such as a solution including ions of nickel. An electrical current is applied and the nanofibers with mounted platinum nanocatalysts are coated with nickel nanocatalysts. Thus, a plurality of nanofibers with a mounted platinum nanocatalyst at the growth tip and mounted nickel catalyst nanoparticles mounted over the nanofiber surface is formed. The nanocatalyst mounted at the growth tip may be any catalyst from which a nanofiber is grown, as discussed herein. The nanocatalyst structure is coated with another metal such as nickel, chromium, cadmium, copper, gold, rhodium, silver, zinc, or any metal that may be placed on a surface by electro-chemical deposition.

In another embodiment, the surface of the bulk catalyst is controlled by CVD or ALD. In ALD, the deposition of each monolayer of material is controlled. Thus, the composition of the bulk catalyst is modified by performing an ALD or a CVD process. By way of non-limiting example, various forms of metals such as zinc, titanium, hafnium, aluminum, tantalum, tungsten, cobalt, iron, manganese, nickel, copper, gold, silver, lanthanum, ruthenium, platinum, iridium, palladium, or rhodium may be deposited by either CVD or ALD processes on either or both of the bulk catalyst and the nanofibers. The ALD or CVD process may be performed either before or after the nanofiber formation. Thus, a metal-containing material may be formed over the bulk catalyst surface prior to nanofiber formation, or alternatively, a metal-containing material may be formed on the surface of the nanocatalyst structure material. In one embodiment, a bulk substrate or bulk catalyst material is substantially covered with a precious metal such as platinum, palladium, ruthenium, or another of the suitable metal catalysts by ALD or CVD. The thickness of the deposited metal over the bulk substrate may be between about 25 nm and about 50 nm, between about 10 nm and about 25 nm, or between about 5 nm and about 10 nm. In one embodiment, the deposited metal has a thickness of less than about 10 nm. In another embodiment, nanofibers are formed from a bulk catalyst with a nanocatalyst structure in the growth tip of each nanofiber. Surfaces of the nanofibers are coated with more nanocatalyst particles by performing ALD or CVD over the supported nanocatalysts. The nanocatalyst deposited on the nanofibers by ALD or CVD may be a different catalyst material than the nanocatalyst embedded in the nanofiber growth tips. Coating the nanofibers with supported nanocatalysts by CVD or ALD is an effective method of increasing the effective surface area of the nanocatalyst structures. Thus, nanocatalyst structures are formed with a nanocatalyst in a nanofiber growth tip and additional nanocatalyst particles on the surface of the nanocatalyst structures. In some embodiments, nanocatalyst particles are deposited on and supported on the outer surface of nanofibers to form nanocatalyst structures including such metals.

In other embodiments, the surface of the bulk catalyst is controlled by the decomposition of organometallic compounds having carbonyl functional groups. That is, organometallic compounds are decomposed on the surface of the bulk catalyst from which the nanofibers are formed. Alternatively, organometallic compounds are decomposed on the surface of the nanofibers containing the nanocatalyst structures. By way of non-limiting example, carbonyls of chromium, manganese, iron, nickel, cobalt, molybdenum, ruthenium, rhodium, tungsten, rhenium, osmium, iridium, and vanadium may be used.

In yet other embodiments, the surface of the bulk catalyst material is controlled by carburizing the surface of the bulk catalyst material, in which the crystalline structure of the bulk catalyst material is partially or substantially saturated with carbon. For example, the bulk catalyst material may be heated in the presence of a carbon-containing material (e.g., charcoal, carbon oxide gases such as carbon monoxide, carbon dioxide, etc.). As the time and temperature of the carburization process increase, the carbon content on the surface of the bulk catalyst increases. Where iron-based catalysts, such as steel, are carburized, carburization may substantially increase the cementite (i.e., iron carbide) in the bulk catalyst material.

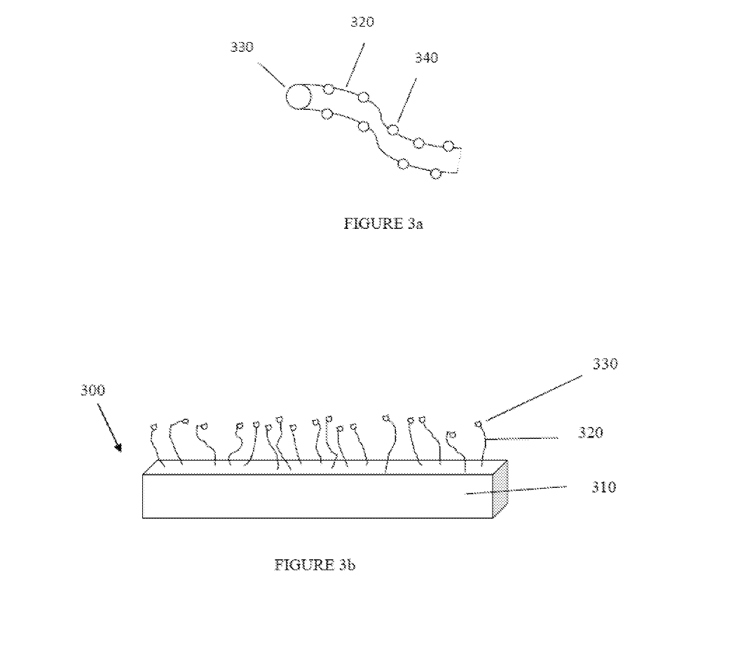

Depositing a metal on a bulk catalyst surface by electro-chemical deposition, decomposing an organometallic compound with a carbonyl functional group, ALD, CVD, or sputtering may result in a supported nanocatalyst comprising more than one metal catalyst. Thus, in one embodiment, a bulk metal is coated with at least another metal by at least one of electro-chemical deposition, decomposition of an organometallic compound, ALD, CVD, or sputtering a material onto the bulk metal. The deposited metal may have a thickness as low as about 1 nm, as low as about 10 nm, or as low as about 25 nm. The nanofibers formed from bulk catalyst produced by these methods may have embedded nanocatalysts in the growth tips including both the bulk metal and the plated metal or metals. In another embodiment, nanocatalyst structures may be further subjected to a sputtering, CVD, ALD, electro-chemical deposition, or carbonyl decomposition process to form metal nanocatalysts on the surface of the nanocatalyst structures. As shown in FIG. 3a, a nanofiber 320 has an embedded nanocatalyst 330 in the growth tip. In one embodiment, additional nanocatalyst 340 may be attached to the exterior surface of the nanofiber 320 by the method that the nanofiber 320 is formed. For example, if the nanofiber is formed by reacting a carbon oxide, such as CO or CO₂, with a reducing agent, such as H₂ or CH₄, the nanofiber 320 may include an embedded nanocatalyst 330 at the growth tip of the nanofiber, and additional nanocatalyst 340 on an exterior surface of the nanofiber 320. In such an embodiment, the embedded nanocatalyst 330 and the additional nanocatalyst 340 may include the same material as the bulk catalyst material from which the nanofiber 320 is grown. Thus, the additional nanocatalyst 340 may be the same material as the embedded nanocatalyst 330, or it may include different material. In one embodiment, additional nanocatalyst 340 may be formed on the nanofiber 320 by at least one of ALD, CVD, electro-chemical deposition, sputtering, and carbonyl decomposition. The formed or deposited metal may be the same or different metals as the bulk catalyst material. In one embodiment, nanofibers are formed with embedded nanocatalysts in the growth tip to form the nanocatalyst structures. Additional catalyst material is deposited on a surface of the nanocatalyst structures by at least one of ALD, CVD, electro-chemical deposition, sputtering, and carbonyl decomposition to secure nanocatalyst particles on an outside surface of the nanofiber. The resulting nanocatalyst structures have a nanocatalyst particle of the bulk metal embedded in the growth tip of the nanofiber and have nanocatalyst particles on the surface of the nanocatalyst structures. In some embodiments, the catalyst on the surface of the nanocatalyst structures include a dissimilar material from (e.g., a material different than) the nanocatalyst particle in the end of the nanofibers. In other embodiments, the nanocatalyst particles are formed on an exterior surface of the nanocatalyst structures. Thus, the nanocatalyst structures may include particles of the bulk catalyst material at the growth tip, and additional catalyst material attached to the inside wall or the outside wall of the nanocatalyst structure. In one embodiment, the additional nanocatalyst particles are attached to an outside wall of the nanocatalyst structure.

In other embodiments, a thin catalytic material is formed or deposited over an inert substrate, such as quartz, silicon, or a ceramic. Nanofibers with embedded nanocatalysts are formed from the thin catalytic material over the substrate. The thin catalytic material may have a thickness as low as, for example, about 1 nm, as low as about 10 nm, or as low as about 25 nm.

Many catalysts are suitable for catalyzing more than one reaction. By way of non-limiting example, a bulk catalyst including iron may catalyze carbon nanofiber formation. The nanocatalyst structures are effective catalysts for reactions such as the Haber-Bosch process, the Fischer-Tropsch process, a methane-reforming (e.g., wet reforming or dry reforming) reaction, a nitrous-oxide decomposition reaction, or any other reaction conventionally catalyzed by iron. In another example, if the bulk catalyst from which nanofibers are formed contains nickel, the resulting nanofibers may be used to catalyze hydrogenation reactions, hydrogen-forming reactions, or any other reaction conventionally catalyzed by nickel or nickel-containing compounds. Alternatively, nanofibers containing nickel, iron, or any other nanofiber may be used to mount nickel nanocatalyst particles by forming nickel nanocatalysts on the nanofiber by at least one of ALD, CVD, organometallic deposition, sputtering, and electro-chemical deposition. In yet another example, if the bulk catalyst from which nanofibers are formed comprises platinum, palladium, ruthenium, or combinations thereof, the resulting nanocatalysts may be used in catalytic converters, hydrogenation, dehydrogenation, catalytic reforming, or other reactions conventionally catalyzed by such precious metals. Thus, bulk catalyst particles may be the nucleating site for the formation of nanofibers: the nanocatalyst becomes embedded in the growth tip of such nanofibers to form nanocatalyst structures that may subsequently be used to catalyze another reaction. The nanocatalyst structures disclosed herein remain catalytically active immediately after, or even during, formation of the nanofibers from which the nanocatalysts are mounted. Thus, the nanocatalyst structure may be catalytically active immediately subsequent to formation of the nanofiber on which it is supported.

Thus, effective nanocatalyst structures particles are created directly from a bulk catalyst surface without acid washing the nanocatalyst structures after nanofiber formation. Catalyst particles may subsequently be deposited onto the nanocatalyst structure. Treatment of the nanocatalyst structure is not required to activate the nanocatalyst structure subsequent to the nanofiber formation.

Forming the nanoparticle catalysts by growing nanofibers, wherein the nanocatalysts are retained in the growth tip of the nanofibers, may be an effective method of forming and mounting nanocatalyst particles. Such methods reduce the likelihood of entrainment of nanocatalyst particles in reaction process streams and also reduce agglomeration, clumping, and pressure drop associated with many nanocatalyst structures. The method of formation of the nanocatalyst structures creates interstices between adjacent nanofibers such that there is reduced clumping or agglomerating between adjacent nanocatalysts; thus the pressure drop across the nanocatalyst structure may be lower than across conventional catalyst structures.

In some embodiments, the formed nanofibers are collected from the bulk catalyst material prior to use as a catalyst material in another reaction. In other embodiments, the nanocatalyst structures catalyze another reaction as they are formed in the reactor. In yet other embodiments, the nanocatalyst structures and the bulk catalyst from which the supported nanocatalysts are grown and transported to another reactor, wherein the nanocatalyst structures catalyze another reaction.

Each time the nanocatalyst structures are collected from the bulk catalyst substrate, the bulk catalyst material may be subjected to any combination of an oxidizing environment, a reducing environment, carburization, ALD, CVD, recrystallization or heat treating, etching, sputtering, and electro-chemical deposition in order to control the uniformity and size of the nanocatalyst structures. Performing any such processes may alter the grain size of the bulk catalyst, thereby altering the size of the nanocatalyst structures. Thus, the size and uniformity of the resulting nanocatalysts may be controlled by controlling the surface of the bulk catalyst material. In some embodiments, the bulk catalyst includes a layer of a precious or expensive metal, such as platinum, palladium, or ruthenium. Nanocatalyst structures are grown over the precious metal and harvested. Nanofibers may be grown until substantially all of the precious metal is consumed and embedded in the formed nanofibers. Then, another cycle of ALD or CVD is performed and the process is repeated. In this manner, substantially all of the as-deposited precious metal is converted into nanocatalyst structure.

After formation of the nanocatalyst structures, the nanocatalyst structures may be functionalized to place various functional groups on the nanocatalyst structure. Functionalization generally refers to the introduction of functional groups to the nanocatalyst structure. The nanocatalyst structures are functionalized with functional groups by contacting the nanocatalyst structures with an appropriate reagent such as an oxidizing agent. In some embodiments, the physical properties of the nanofiber materials are substantially modified by the application of additional substances to the nanofiber surface. In some embodiments, after the nanocatalyst structures are formed, the reaction gas mixture is removed from the reactor and replaced with a gas mixture for modifying or functionalizing the nanocatalyst structures. The nanocatalyst structures may be functionalized with various molecules that link or bond the nanocatalyst structures together or to another molecule. Non-limiting examples of functionalization agents include potassium chlorate, sulfuric acid, nitric acid, persulfate, hydrogen peroxide, carbon dioxide, oxygen, steam, nitric oxide, nitrogen dioxide, nitrous oxide, ozone, chlorine dioxide, and functional groups such as amino acids, amides, carbonyls, esters, nitriles, sulfates, sulfonyls, thiols, halogens, halides, hydroxyls, aldehydes, aromatics, non-aromatic rings, peptides, phosphates, alcohols, or other groups.

In embodiments in which the nanocatalyst structures are harvested from the bulk catalyst, the nanocatalyst structures may be removed from the bulk catalyst surface in a number of ways, such as by mechanical or chemical means. By way of non-limiting example, the nanocatalyst structures are removed from the bulk catalyst surface by agitating the surface of the bulk catalyst such as by shaking, abrading, scraping, rinsing, or washing the nanocatalyst structures from the bulk catalyst surface. The nanocatalyst structures are collected by any suitable method, and the various methods of collection are not discussed in detail herein.

FIG. 3b shows a plate structure 300 including nanofibers 320 with embedded nanocatalyst 330 at the growth tip. The bulk catalyst 310 may have any selected shape such as spherical, pellet, cylindrical, plate, or sheet. Note that although FIG. 3b shows the nanofibers 320 on only one surface, the nanofibers 320 may grow on multiple surfaces of the bulk catalyst 310, thereby increasing the effective surface area of the nanofibers 320 (i.e., by increasing the number of nanofibers 320). The nanofibers 320 with embedded nanocatalyst 330 at the growth tip may be harvested from the bulk catalyst 310. Alternatively, the bulk catalyst 310 with nanofibers 320 with embedded nanocatalyst 330 particles at the growth tip may be transferred to another reactor and used to catalyze another reaction with the nanofibers 320 and embedded nanocatalyst 330. In one embodiment, the nanofibers 320 with embedded nanocatalyst 330 at the growth tip are transferred with the bulk catalyst 310 to catalyze another reaction.

The weight percent of nanocatalyst particles at or near the growth tip may depend on the diameter of the nanocatalyst, the diameter of the nanofiber, and the length of the nanofiber. The active catalyst content of the nanocatalyst structure will therefore largely be a function of the mass of the nanocatalyst structure. The length, and therefore mass, of the nanofiber may be a function of the frequency of nanofiber collection. In some embodiments, the nanofiber is grown for a relatively short time, e.g., just enough to lift nanocatalyst particles off of the bulk catalyst 310. The nanofibers 320 are collected and the process is repeated. Thus, the weight percent of nanocatalyst particles on the nanofiber may depend on the exposure time of the developing nanofiber to the reactant gases. Generally, the longer the nanofibers, the lower the weight percent of embedded nanocatalyst in the nanocatalyst structures. Thus, to increase the weight percent of embedded nanocatalyst, the mean length of the nanofibers is shortened, such as by reducing reactant gas concentrations, reducing reactant gas exposure times, increasing harvesting rates, or any combination of the foregoing. By way of non-limiting example, the mean length-to-diameter ratio of the nanofibers may be on the order of 10,000:1, 1,000:1, 100:1, or even as low as 10:1. A greater effective surface area of active nanocatalyst results from maintaining a low length-to-diameter ratio, without forming additional nanocatalyst particles by methods such as ALD, CVD, electro-chemical deposition, carbonyl decomposition, or sputtering of catalyst material onto the surface of the nanocatalyst structure. The nanocatalyst structures may include at least about 90%, at least about 50%, at least about 30%, or even at least about 10% by weight of the nanocatalyst particles. By way of non-limiting example, if the nanocatalyst includes platinum, palladium, ruthenium, nickel, or chromium, the weight percent of such metals in the nanocatalyst structure may be at least about 1% by weight. In some embodiments, the nanocatalyst structures include only nanocatalyst particles in the growth tip of the nanofibers.

The overall effective surface area of the active catalyst material is increased by increasing the density of nanofibers 320. The density of nanocatalyst structures on the bulk catalyst 310 is increased by decreasing the mean grain diameter of the bulk catalyst 310, thereby reducing the mean diameter of the resulting nanofibers 320 of the nanocatalyst structures. The mean grain diameter is decreased by any of the methods discussed herein. The density of nanofibers 320 on the bulk catalyst 310 may be greater than about 1.0×10¹⁰ nanotubes per mm² of surface area, greater than about 1.0×10⁹ nanotubes per mm², or greater than about 1.0×10⁸ nanotubes per mm².

A cylindrical structure 400 including a bulk catalyst 410 from which nanofibers 420 may be formed is shown in FIG. 4. Nanofibers 420 with embedded nanocatalyst 430 particles are formed on the inside diameter of the bulk catalyst 410 structure. Alternatively, the bulk catalyst 410 is a thin sheet or plate. In some embodiments, nanofibers 420 are grown on the surface of the sheet or plate, the sheet or plate is rolled into a cylindrical structure 400, and the opposite edges are attached, such as by welding. The resulting cylindrical structure 400 includes nanofibers 420 on the inside surface of the cylindrical structure 400. The sheet or plate may be steel or steel coated with a thin layer of material of at least another catalyst such as ruthenium, platinum, or palladium. By way of non-limiting example, a steel sheet is coated with platinum, palladium, or ruthenium by ALD, CVD, or electro-chemical deposition. Nanofibers 420 with nanocatalyst particles 430 of such metals are formed on the bulk catalyst 410 surface when exposed to suitable reaction conditions for the formation of the desired nanofibers 420. Alternatively, nanocatalyst structures are grown over the steel plate. Then, platinum, palladium, or ruthenium is formed on the nanofiber surfaces by ALD, CVD, sputtering, electro-chemical deposition, or carbonyl decomposition. The plate with embedded nanocatalyst 430 is then rolled into a cylindrical shape and welded. The cylindrical structure 400 may, for example, be a relatively inexpensive catalytic converter for automobiles.

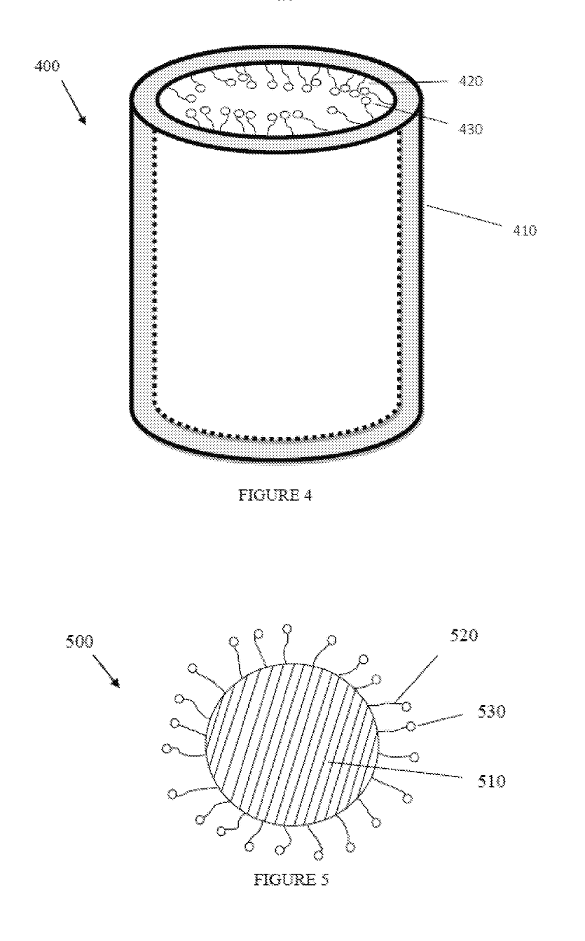

A structure 500 with nanofibers 520 and embedded nanocatalyst 530 particles on a growth tip of the nanofibers 520 grown from a bulk catalyst 510 is shown in FIG. 5. The bulk catalyst 510 may be in spherical, pellet, or complex form, such as is commonly used as packing material in packed-bed catalytic reactors. Nanofibers 520 are formed on the surface of the bulk catalyst 510. Once the nanofibers 520 with embedded nanocatalyst 530 are formed, the spherical bulk catalysts 510 with attached nanofibers 520 and embedded nanocatalyst 530 may be coated with a thin layer of material of at least another catalyst such as ruthenium, platinum, palladium, nickel, or other suitable metal. The structures 500 are transferred to another reactor to catalyze another reaction. Such form is beneficial to catalyze reactions in packed-bed or fluidized-bed reactors. Such bulk catalyst 510 in spherical or cylindrical form may be packaged and shipped to be placed in a fluidized-bed reactor or packed-bed reactor.

In FIGS. 3b, 4, and 5, only a single generation of nanofibers 320, 420, 520 with embedded nanocatalyst 330, 430, 530 is shown. In practice, multiple generations of nanofibers 320, 420, 520 may be grown, such that the bulk catalyst 310, 410, 510 structure becomes compacted, to any desired extent, with nanofibers 320, 420, 520 with embedded nanocatalyst 330, 430, 530. The compacted material remains porous, and thus, the resulting structure in total can be used as a catalyst.

The nanocatalyst structures may be formed into generally accepted forms of industrial catalyst. Once the nanocatalyst-containing nanotubes have been collected, the nanocatalysts may be processed into bulk porous form, suitable for use in various reactor configurations. The nanocatalyst product may be processed by methods such as extrusion, powder agglomeration, compaction, or pelletization. For example, the nanocatalyst structure powder may be pelletized and placed into bulk form suitable for various reactor configurations. By way of non-limiting example, if the nanocatalyst structures are harvested as an agglomerate powder, the powder may be pressed into pellets or other suitable shapes and sizes for use in packed-bed or fluidized-bed reactors. The pellets are formed by compressing or extruding the nanocatalyst structures, heating, and forming into a pellet shape. During the heating process, chemical agents may be added such that the nanocatalyst structures are functionalized concurrently with the pelletization process. Pelletizing the nanocatalysts is an effective means of reducing the tendency of nanocatalyst particles to elutriate in process streams. The pelletized nanocatalysts remain porous enough that the reactants can easily diffuse through the resulting structure such that the high effective surface area of the nanocatalysts is not decreased. In some embodiments, the nanocatalyst structures are agglomerated, compacted, or pelletized directly after harvesting from the bulk catalyst surface. Various shapes of nanocatalyst structures may be formed by, for example, pressing, extruding, or otherwise forming the desired shapes. The various shapes may include large-scale shapes to be used as catalysts in industrial processes. The nanocatalysts may be further processed to improve the mechanical properties of the shapes by sintering, for example. Pellets of nanocatalyst structures are formed with significantly high weight percent of the nanocatalyst particles by pelletizing supported nanotubes formed by any of the methods described above. In other embodiments, the nanocatalyst structures are pressed into thin sheets of material. Forming nanocatalyst structures into thin sheets creates a material with a high surface area of active nanocatalyst structure and high porosity for reactant diffusion.

The nanocatalyst structures may be used to catalyze another reaction within the same system in which the nanocatalyst structures are formed. For example, a reactor may include a bulk catalyst material or other catalyst structure for catalyzing the formation of nanocatalyst structures, as described above. A first set of reactant streams may be flowed into the reactor to form a plurality of nanocatalyst structures. In one embodiment, after the nanocatalyst structures are formed, a second set of reactants may pass through the reactor and the nanocatalyst structures may catalyze a second reaction between the second set of reactants. In another embodiment, the nanocatalyst structures catalyze a reaction between the second set of reactants in a reactor other than the reactor in which the nanocatalyst structures are formed. Thus, a system for catalyzing a reaction may include a first reactor for forming a plurality of nanocatalyst structures and at least a second reactor for catalyzing a reaction with the plurality of nanocatalyst structures.

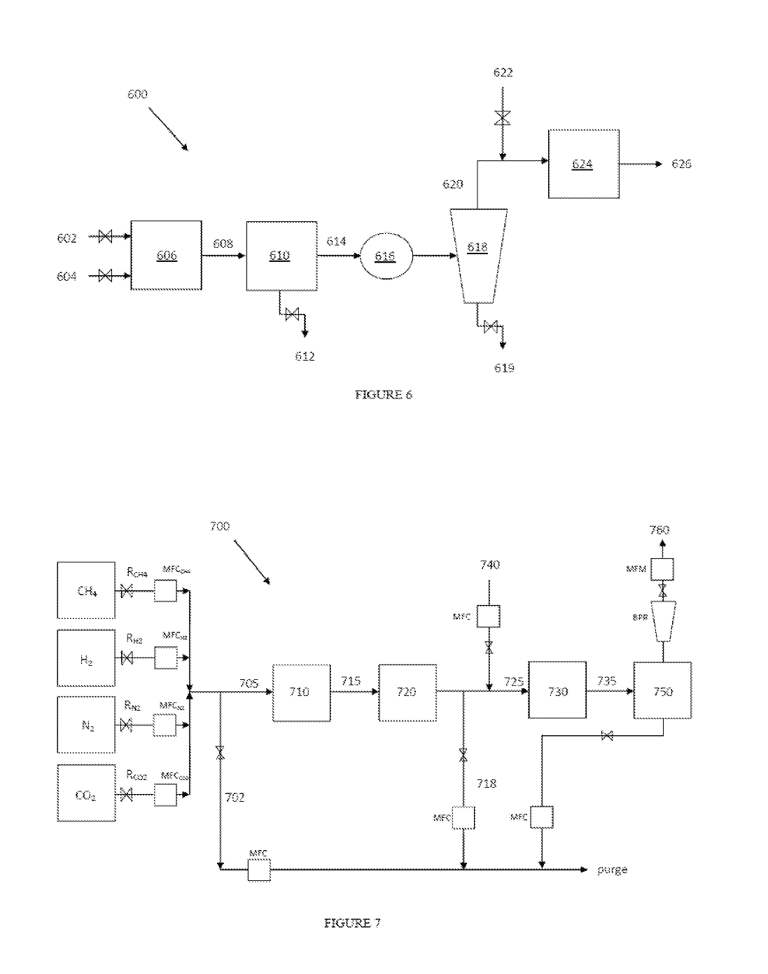

FIG. 6 shows a dual-reactor configuration 600 in which nanocatalyst structures may be formed in a continuous or batch process. Reactant gas streams 602 and 604 are mixed in mixing means 606, which may be a mixing valve or a mixing vessel, to form mixed feed gases 608. Reactant gas streams 602, 604 are suitable gases for forming nanocatalyst structures. The mixed feed gases 608 are transported to a first reactor 610 wherein nanocatalyst structures are formed. The first reactor 610 includes a bulk catalyst material suitable for the formation of the nanocatalyst structures. The first reactor 610 may be a vessel with reactor walls and components that include suitable bulk catalyst for the formation of nanocatalyst structures. Nanocatalyst structures are removed from the reactor in nanocatalyst structure stream 612 or may be removed directly from the reactor by either chemical or physical means. First reactor effluent stream 614 may be cooled in a heat exchanger 616. In continuous operations, the cooled first reactor effluent stream 614 may be transported to a solids separator 618. In the solids separator, nanocatalyst structures that have elutriated with the first reactor effluent stream 614 may be removed and collected via nanocatalyst structure stream 619. Fluid stream 620 exiting the solids separator 618 may mix with second reactor feed stream 622 and enter the second reactor 624. In other embodiments, the second reactor feed stream 622 and the second reactor 624 are separated from the fluid stream 620. The second reactor 624 includes nanocatalyst structures that were previously formed in the first reactor 610. Product stream 626 exits the second reactor 624 and may be subjected to further processing. Although FIG. 6 shows that the resulting nanocatalyst structures may be used to catalyze another reaction in a reactor other than the reactor in which the nanocatalyst structure are formed, the other reaction may take place in the same reactor. In such an embodiment, a first set of reactant gases are flowed to the first reactor 610 to form nanocatalyst structures. With the nanocatalyst structures formed in the first reactor 610, a second set of reactant gases may be flowed into the reactor in which a reaction between the second set of reactant gases is catalyzed by the nanocatalyst structures.

Another dual-reactor system 700 is illustrated in FIG. 7. A first reactor 710 is configured and coupled to several source gas streams and a purge gas source, such as nitrogen. By way of non-limiting example, if the nanocatalysts are to be mounted on carbon nanotubes, the reactant gases may include carbon dioxide, methane, and/or hydrogen. Each source gas may be coupled to a flow controller such that the flow rate of each reactant gas is controlled. The purge gas may or may not be coupled to a flow controller. The first reactor 710 may be formed from a bulk catalyst material with nanocatalyst structures growing upon the wetted surfaces of the first reactor 710. For example, the first reactor 710 may include at least one surface (e.g., a wall) that includes a material suitable for catalyzing formation of nanocatalyst structures. The material may include a thin layer of deposited material formed by at least one of ALD, CVD, electro-chemical deposition, or sputtering. The first reactor 710 may include a means for depositing additional catalytic material onto an exterior surface of at least a portion of the plurality of nanocatalysts after nanocatalyst structures are formed in the first reactor 710. Such means may include a means for performing at least one of ALD, CVD, electro-chemical deposition, carbonyl deposition, and sputtering. In another embodiment, the means for depositing additional catalytic material is outside the first reactor 710 and may include a separate chamber.

The dual-reactor system 700 includes two reactors: a first reactor 710 and a second reactor 730. In FIG. 7, the first reactor 710 and the second reactor 730 are both illustrated as batch reactors with a single pass of the reaction gases, although the dual-reactor system 700 may include multiple passes and continuous reactors. The use of dual reactors is for convenience only and either reactor may operate individually.

A primary advantage of operating two or more reactors in series is that each reactor can be operated, if desired, at different reaction conditions, with different bulk catalysts and thus, use the reaction gas stream efficiently. The first reactor 710 uses a portion of the inlet reaction gas mixture 705 and the second reactor 730 uses a portion of the first effluent stream 715. Although FIG. 7 shows that the inlet reaction gas mixture 705 may include CH₄, H₂, N₂, and CO₂, the inlet reaction gas mixture 705 may include any number of reactants. In particular circumstances, additional reactors may be placed in series to optimize the conversion of reactant gases and to control reactant gas losses. Thus, pressure control means (i.e., compressor, pressure control valves, etc.) and temperature control means (i.e., reactor tube furnace, heat exchangers, etc.) may be placed between the first reactor 710 and the second reactor 730. When reactors are placed in series, interstage product removal, interstage treatment 720 (such as interstage cooling, product removal, removal of contaminants from effluent streams, etc.), interstage addition of one or more reaction gas constituents and methods of heating, heat recovery, etc., may be desirable.

To operate in batch mode, the bulk catalyst may be placed in the first reactor 710 and periodically removed as desired growth of nanofibers is achieved. The first reactor 710 can then be removed from the dual-reactor system 700, as for example, when the reactor 710 becomes compacted with nanocatalyst structures, and used in another apparatus as both the catalyst and the reaction vessel. For example, the second reactor 730 may include a reactor such as the first reactor 710 in which nanocatalyst structures have been formed and compacted. Then, a second set of reactants may be flowed through the second reactor 730 that contains the compacted nanocatalyst structures. The first reactor 710 can have many different shapes and thus produce nanocatalyst structures packaged for use in many different processes and configurations.

The pressure of the first reactor 710 may be controlled by pressure controllers, both upstream and downstream of the first reactor 710. The temperature of the first reactor 710 is controlled by a reactor tube furnace or any other temperature control means, such as an external heat exchanger. The first reactor 710 may operate at pressures of from atmospheric pressure to about 90,000 kPa (900 bar), such as from about 200 kPa (2.0 bar) to about 1000 kPa (10 bar). The first reactor 710 may operate at temperatures of from about 550° C. to about 1200° C., such as from about 650° C. to about 850° C.

The first effluent stream 715 is effluent from the first reactor 710 and includes nanocatalyst particles and unreacted reactants. The supported nanocatalyst nanotubes are retained within the first reactor 710, and periodically removed in batches.

The first effluent stream 715 flows to the interstage treatment 720 (e.g., a condensing means, interstage cooling, product removal of contaminants, etc.) where it is cooled to condense at least a portion of the water present in the first effluent stream 715 to levels suitable for a reaction in the second reactor 730. Heat may be recovered from the first effluent stream 715, such as by passing the first effluent stream 715 through at least the interstage treatment 720. Any gas or liquid streams (e.g., the source gas stream 705, first effluent stream 715, or other process stream) may be processed (e.g., in heat exchangers) as known in the art for overall energy optimization.

After passing through the interstage treatment 720, a portion of the first effluent stream 715 may be recycled (not shown) back to the first reactor 710 or it may be flowed to a vent. All of, or a portion of the first effluent stream 715 may comprise a second reactor inlet stream and may be flowed to the second reactor 730. The temperature of the second reactor 730 may be controlled by a reactor tube furnace or other temperature control means. The pressure of the second reactor 730 may be controlled by a pressure regulator or pressure controller. If it is desired to operate the second reactor 730 at a higher pressure than the first reactor 710, a compressor (not shown) may be provided between the first reactor 710 and the second reactor 730. Thus, the temperature and pressure of the second reactor 730 may be controlled to optimal conditions for the second reaction.

The second reactor 730 may be used to carry out a reaction catalyzed by the nanocatalyst structures. A second reactant stream 740 may be combined with the cooled first effluent stream 715 to form the second reactor inlet stream 725. The second reactor inlet stream 725 contains reactants for which reaction is catalyzed by the nanocatalyst structures.

Reaction conditions of the second reactor 730 are tuned for the particular reaction being catalyzed by the nanocatalyst structures. For example, the reaction time, temperature, pressure, partial pressures of reactants, or catalyst properties may be optimized to produce the desired reaction products of the second reaction. The second reactor 730 may operate at pressures of from very low pressures to about 90,000 kPa (900 bar), or such as from about 200 kPa (2.0 bar) to about 1000 kPa (10 bar). The second reactor 730 may operate at temperatures of from about 550° C. to about 1200° C., such as from about 650° C. to about 800° C. The pressure drop through the second reactor 730 may be negligible because there is very low pressure drop through the nanocatalyst structures.

By way of non-limiting example, the second reactor 730 may be a solid stainless steel tube or pipe. The tube or pipe is filled with nanocatalyst structure material and the nanocatalyst structure material is compressed by compacting nanocatalyst structures by pressing using a suitable die configured to fit the reactor (stainless steel vessel, tube, or pipe) forming a plug reactor wherein the reactant stream flows through the resulting porous plug of nanocatalyst structures. In another embodiment, the nanocatalyst structures are pelletized and placed into the second reactor 730 as in a packed-bed reactor. Thus, the system may include means for pelletizing the nanocatalyst structures formed in the first reactor 710. Such means may include an extruder, compactor, or sintering means. Alternatively, the nanocatalyst structures are not harvested from the bulk catalyst and the bulk catalyst with attached nanocatalyst structures is transferred to the second reactor 730. The second reactor 730 may be a packed-bed reactor, a fixed-bed reactor, or a moving-bed reactor. In one embodiment, the first reactor 710 includes a fluidized-bed reactor designed to retain the bulk catalyst while allowing the nanocatalyst structures to be entrained in the reactor effluent flow and to be lofted out of the reaction zone upon reaching a particular size. The shape of the first reactor 710 and the gas flow rates influence the residence time of the elutriates and the corresponding size and length of the nanotubes. Alternatively, the first reactor 710 may include continuous reactors, wherein the solid nanotubes are removed from the catalyst as the nanotubes are formed. In some embodiments, a solid catalyst or catalyst mounted on a solid substrate moves through a flowing gas stream, the resulting nanotubes are harvested, and the solid surface is renewed and reintroduced to the reactor.

In some embodiments, the first reactor 710 and the second reactor 730 may be combined. Thus, two separate reactions may occur in a single reactor. For example, nanocatalyst structures are formed and, at the same time, the nanocatalyst structures catalyze another reaction. Alternatively, a first set of reaction gases pass through the reactor, thereby forming nanocatalyst structures on the bulk catalyst. Then, a second set of reaction gases (e.g., the second reactor reactant stream 740) enter the reactor via an alternate feed line and the nanocatalyst structure in the reactor catalyzes another reaction as it forms. In a continuous process in which the first and second sets of reactions occur simultaneously, the nanocatalyst structures may be continuously removed from the reactor.

Effluent from the second reactor 730 may flow into the product removal system 750 where one or more constituents of the second effluent stream 735 are removed. For example, the product removal system 750 may include one or more condensers for removing condensable constituents and may include one or more solids separators for removing such constituents. Final product stream 760 exits the product removal system 750 and may be collected or further processed. The second effluent stream 735 gases may be vented, or a portion may be recycled back (not shown) to the first reactor 710, as described in more detail below. The second effluent stream 735 may flow downstream for further processing or purification steps. For example, the second effluent stream 735 may pass through various separation or purification stages, such as through a flash drum, distillation column, or solid/liquid separator, depending on the specific products formed in the second reactor 730.

The dual-reactor system 700 shows specific means for regulating the pressure to the inlet of the first reactor 710 and for regulating the pressure from the outlet of second reactor 730. For example, various valves, pressure regulators (labeled as “R”), back pressure regulators (labeled as “BPR”), mass flow controllers (labeled as “MFC”) and mass flow meters (labeled as “MFM”) are shown and are not described in detail herein as many variants and application-specific implementation may be adjusted for the desired overall reactor configuration. Also shown are means for regulating a bleed stream 702 from the inlet of the first reactor 710 and a bleed stream 718 from the first effluent stream 715. The bleed stream 702 and the bleed stream 718 may be a used for purging the dual-reactor system 700 and controlling the accumulation of undesired constituents in the system 700. The bleed stream 702 and the bleed stream 718 may also be used to control the pressure of the dual-reactor system 700.

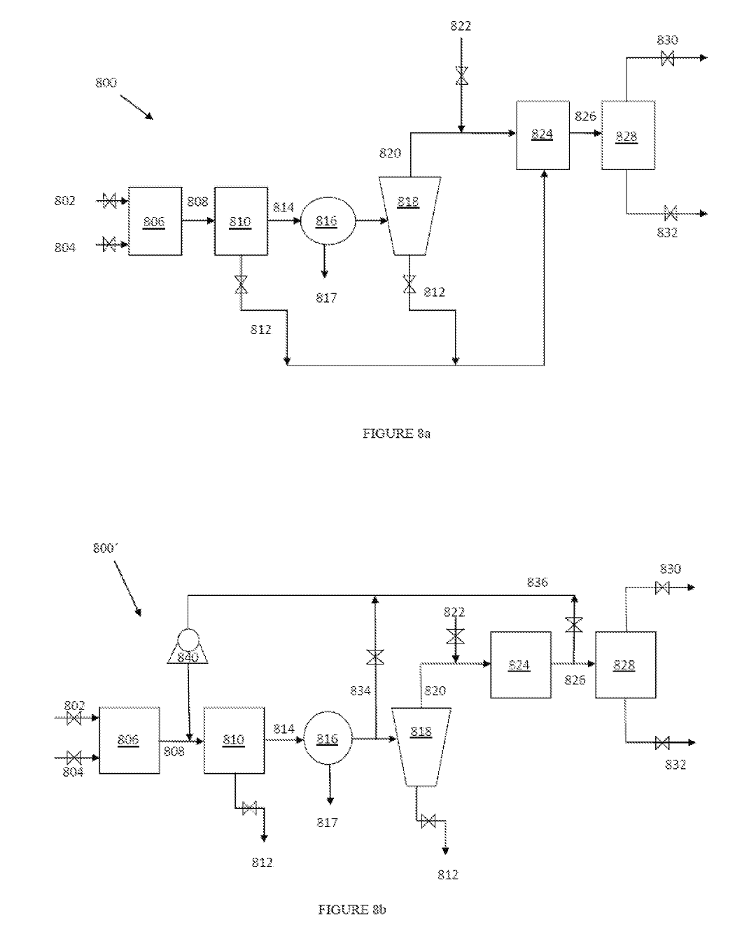

Although the dual-reactor configuration 700 in FIG. 7 is shown as a batch reactor system, continuous reactor designs may also be readily implemented, as shown in FIG. 8a. For example, a first reactor 810 may be a fluidized-bed reactor. In continuous operation, suitable means for removing nanocatalyst structures from the first reactor 810 are implemented. For example, if first reactor 810 is a fluidized-bed reactor, the nanocatalyst structures product will be elutriated from the surface of the bulk catalyst in the first reactor 810 and become entrained in a first effluent stream 814. Stream 812, which includes nanocatalyst structures from the first reactor 810 and from the separation means 818, is flowed into a second reactor 824.

In continuous operation, reactor feed streams 802 and 804 are mixed in the mixer 806 to form the mixed reactor inlet stream 808. The mixed reactor inlet stream 808 includes suitable reactants to form nanofibers in the first reactor 810. The first reactor 810 includes bulk catalyst material to catalyze the formation of nanofibers and nanocatalyst structures as described herein. Nanofibers may be collected from the first reactor 810 by various collection means not described in detail herein. The first reactor effluent stream 814 may be cooled in a heat exchanger 816 where condensable materials may be collected and removed in a condensable stream 817.

The nanocatalyst structures may pass through a lock drum or other separation means 818 to control the release of the reaction gases and to purge the nanocatalyst structures of reaction gases prior to removal of the nanocatalyst structures. The nanocatalyst structures may flow through a cyclone or other separation means 818 to remove and collect the nanocatalyst structures that may be entrained in the first reactor effluent stream 814. The separation means 818 may include devices such as a cyclone separator, bag house, electrostatic precipitator, etc. Other suitable means for removing the nanocatalyst structures from the first reactor 810 that conserve reaction gases and minimize worker and environmental exposure to the reaction gases may be selected based on design objectives.

A fluid stream 820 exiting the separation means 818 includes any unreacted gases, product gases, and uncondensed gases from the first reactor 810. The fluid stream 820 is mixed with a second reactor feed stream 822 prior to entering the second reactor 824. Second reactor feed stream 822 includes reactants, the reaction of which is catalyzed by supported nanocatalysts formed in the first reactor 810. The second reactor 824 includes nanocatalyst structures formed in the first reactor 810 and may catalyze a variety of reactions. A second reactor effluent stream 826 may be separated and purified in a product removal system 828 that may include condensers, solids separators, distillation columns, solid/liquid separators, flash drums, or other separation or purification equipment. The product removal system 828 may separate the second reactor effluent stream 826 into a solid product stream 832 and a gas or liquid product stream 830.

Though the dual-reactor system 800 is shown with a single pass of the reaction gases through the system 800, recirculation of at least a portion of the reactor first effluent stream 814 may be readily implemented, as shown in system 800′ in FIG. 8b. In FIG. 8b, like numerals represent similar elements as those shown and described with respect to FIG. 8a. A portion of the first reactor effluent stream 814 may be recycled back to the first reactor 810 inlet via a first reactor recycle stream 834. The first reactor recycle stream may be recycled back to the mixing means 806 or to the inlet of the first reactor 810. The economy in reducing reaction gas cost by recirculating at least a portion of the first reactor effluent stream 814 will be apparent in particular implementations. A compressor 840 or other suitable motive device may recirculate the first reactor recycle stream 834 at the inlet pressure of the first reactor 810.

A portion of second reactor effluent stream 826 may optionally be recycled via a second reactor recycle stream 836, in total or in part, and mixed with the first reactor inlet stream 808 entering the first reactor 810. In another embodiment, the second reactor recycle stream 836 may be recycled back to the inlet of the second reactor 824 rather than to the first reactor inlet stream 808 or the mixer 806. The second reactor effluent stream 826 may be dried, preheated, and otherwise treated prior to recycle. A portion of the second reactor effluent stream 826 may optionally flow to a vent. Although FIG. 8b depicts recycle streams 834 and 836 in a continuous mode of operation, similar recycle streams may be implemented when the reactors are operated in batch mode. In other words, in batch mode, the nanocatalyst structures may not be collected during operation of the reactors, however, the reactant gases may circulate and recycle through the first reactor 810 and second reactor 824.

1. A method, comprising:
reacting gaseous reactants in a reaction zone in the presence of a bulk catalyst material to grow nanocatalyst structures comprising a mass of nanofibers having at least one particle of the bulk catalyst material attached to a growth tip of a substantial quantity of the nanofibers of the mass of nanofibers.

2. The method of claim 1, further comprising catalyzing at least a second reaction with the nanocatalyst structures.

3. The method of claim 1 wherein reacting gaseous reactants in a reaction zone comprises reacting a gaseous carbon source with a reducing gas in the reaction zone.

4. The method of claim 1, further comprising depositing additional catalytic material on at least one of an exterior surface and an interior surface of a substantial quantity of the nanocatalyst structures.

5. The method of claim 4, wherein depositing additional catalytic material on at least one of an exterior surface and an interior surface of a substantial quantity of the nanocatalyst structures comprises depositing at least one of platinum, palladium, and ruthenium on at least one of an exterior surface and an interior surface of a substantial quantity of the nanocatalyst structures.

6-8. (canceled)

9. The method of claim 3, wherein reacting a gaseous carbon source with a reducing gas comprises reacting a carbon oxide with at least one material selected from the group consisting of hydrogen, methane, hydrocarbon gases, and alcohols.

10. The method of claim 2, wherein catalyzing at least a second reaction with the mass of nanocatalyst structures comprises catalyzing at least one of a catalytic reforming reaction, a hydrogenation reaction, a dehydrogenation reaction, a Fischer-Tropsch reaction, a Haber-Bosch reaction, a methane-reforming reaction, and a nitrous-oxide decomposition reaction.

11-12. (canceled)

13. The method of claim 4, further comprising forming a layer of catalytic material on a surface of an inert substrate material to form the bulk catalyst material.

14. The method of claim 13, wherein forming a layer of catalytic material on a surface of an inert substrate material to form the bulk catalyst material comprises forming a layer of at least one element of Groups 5 through 11 of the periodic table.

15. The method of claim 13, wherein forming a layer of catalytic material on a surface of an inert substrate material to form the bulk catalyst material comprises forming a layer of the catalyst material by at least one of atomic layer deposition, chemical vapor deposition, electro-chemical deposition, and sputtering.

16. A system for catalyzing a reaction using nanocatalysts, comprising:
at least one first reaction zone for forming a mass of nanocatalyst structures and a tail gas from a first combination of reactants, wherein at least one surface of the first reaction zone comprises a bulk catalyst material for catalyzing the formation of the mass of nanocatalyst structures; and
at least another reaction zone for catalyzing another reaction with a second combination of reactants.

17. The system of claim 16, wherein the at least one surface of the first reaction zone comprises at least one element of Groups 5 through 11 of the periodic table.

18. The system of claim 16, wherein the at least one surface of the first reaction zone comprises a film of catalytic material having a thickness less than about 10 nm.

19. The system of any of claim 16, wherein the at least another reaction zone comprises at least one of a packed-bed reactor and a fluidized-bed reactor, wherein the at least one of a packed bed reactor and a fluidized-bed reactor comprises pellets comprising at least some of the mass of nanocatalyst structures formed in the at least one first reaction zone.

20. The system of claim 16, further comprising a condensing means for removing water from the tail gas to control the concentration of water in at least one of the first combination of reactants and the second combination of reactants.

21. (canceled)

22. The system of claim 16, further comprising a collection means for collecting the mass of nanocatalysts downstream of the at least one first reaction zone, the collection means comprising at least one of a cyclone separator, a bag house, a scrubber, and an electrostatic precipitator.

23. (canceled)

24. The system of claim 16, further comprising a means for pelletizing the mass of nanocatalyst structures, the means for pelletizing the mass of nanocatalyst structures comprising at least one of a means for pressing, a means for extruding, and a means for sintering.

25. (canceled)

26. The system of claim 16, further comprising a means for recycling at least a portion of a tail gas leaving the at least another reaction zone to at least one of the at least one first reaction zone and the at least another reaction zone.

27. (canceled)

28. The system of claim 16, further comprising a means for depositing additional catalytic material onto an exterior surface of at least a portion of the mass of nanocatalyst structures.

29. A composition of matter, comprising:
a nanocatalyst structure comprising a nanofiber with at least one particle of catalyst material embedded on at least one end of the nanofiber; and
at least another particle of catalyst material attached to an exterior surface of the nanocatalyst structure.

30-42. (canceled)
